(19) United States
(12) Patent Application Publication
(10) Pub. No.: US 2024/0250542 A1
(43) Pub. Date: Jul. 25, 2024

(54) CHARGING DEVICE FOR WEARABLE DEVICE AND WEARABLE DEVICE ASSEMBLY

(71) Applicant: Harman International Industries, Incorporated, Stamford, CT (US)

(72) Inventors: Tieyi Liang, Shenzhen, Guangdong (CN); Yi Zhang, Shenzhen, Guangdong (CN); Bin Cai, Shenzhen, Guangdong (CN)

(21) Appl. No.: 18/559,014

(22) PCT Filed: May 8, 2021
(86) PCT No.: PCT/CN2021/092385

§ 371 Date: Nov. 3, 2023

(51) Int. Cl. H02J 7/00; H02J 7/34; H04R 1/10

(52) U.S. Cl. CPC H02J 7/0044; H02J 7/00034; H02J 7/0013; H02J 7/342; H04R 1/1016; H04R 1/1025; H02J 2207/10; H02J 2207/20

(57) ABSTRACT

A charging device for wearable device and a wearable device assembly are provided. The charging device comprises: a power source; a DC-DC converter electrically connected to the power source, and adapted to receive input from the power source and provide a voltage output; a controller that is in communication with the DC-DC converter; a linear charger electrically connected to the DC-DC converter and adapted to receive the voltage output from the DC-DC converter and provide a voltage output to charge a battery in the wearable device via a power connection between the charging device and the wearable device. The wearable device assembly comprises: a charging device; a wearable device comprising a battery, wherein the charging device is adapted to charge the battery of the wearable device via a power connection between the charging device and the wearable device.

### TECHNICAL FIELD

This disclosure relates in general to a charging device for a wearable device and a wearable device assembly, and particularly relates to a charging case for earbuds and an earbuds assembly.

### BACKGROUND

In recent years, wireless earbuds, especially TWS earbuds, have become more and more popular. When not in use, wireless earbuds are usually stowed in a charging case, which can contain and charge the earbuds stowed therein. As compared to wired earbuds, wireless earbuds normally have a relatively large size at least due to a battery in the wireless earbuds. Accordingly, there is a need for wireless earbuds having a smaller size.

When charging the earbuds stowed therein, normally the charging case first boosts a voltage from a battery in the charging case to 5V by using a booster IC, and then supplies the 5V voltage to the earbuds. A linear charger IC in the earbuds receives the 5V voltage from the charging case, and regulates a voltage drop between the 5V voltage and a battery in the earbud by inserting a resistive device to keep load voltage stable. The amount of loss is equal to the voltage drop multiplied by the current. The charging efficiency is typically 70% or less.

If the charging efficiency is low, a bigger battery may be needed in the charging case, and extra heat will be generated due to the low charging efficiency. The extra heat generation may also shorten the life of the batteries in both the charging case and the earbuds, and cause discomfort to users. Accordingly, there is a need for higher charging efficiency in order to maximize life and usage of the earbuds, while keeping a size of the batteries as small as possible.

### SUMMARY OF THE INVENTION

According to one aspect of the disclosure, a charging device for a wearable device is provided. The charging device comprises: a power source; a DC-DC converter electrically connected to the power source, and adapted to receive input from the power source and provide a voltage output; a controller that is in communication with the DC-DC converter; a linear charger electrically connected to the DC-DC converter and adapted to receive the voltage output from the DC-DC converter and provide a voltage output to charge a battery in the wearable device via a power connection between the charging device and the wearable device.

In one or more embodiments of the present disclosure, the DC-DC converter is a buck-boost regulator adapted to provide a variable voltage output.

In one or more embodiments of the present disclosure, the controller is electrically connected to the linear charger and/or the power connection and adapted to receive input from the linear charger and/or the power connection, and adapted to communicated with the buck-boost regulator so as to control the buck-boost regulator to adjust its voltage output based on the input from the linear charger and/or the power connection.

In one or more embodiments of the present disclosure, wherein the charging device is a charging case for earbuds, the wearable device is a pair of earbuds, and the power source comprises a battery.

In one or more embodiments of the present disclosure, wherein the linear charger comprises a first and second linear chargers.

In one or more embodiments of the present disclosure, the first linear charger is electrically connected to the buck-boost regulator and adapted to receive a first voltage output from the buck-boost regulator and provide a voltage output to charge a first earbud of the pair of the earbuds, the second linear charger is electrically connected to the buck-boost regulator and adapted to receive a second voltage output from the buck-boost regulator and provide a voltage output to charge a second earbud of the pair of the earbuds.

In one or more embodiments of the present disclosure, the first voltage output is independent from the second voltage output.

In one or more embodiments of the present disclosure, the first voltage output is 0.2-0.3 V higher than the voltage of the battery in the first earbud, and the second voltage output is 0.2-0.3 V higher than the voltage of the battery in the second earbud.

In one or more embodiments of the present disclosure, the power connection is established through an engagement between contacts of the charging case and contacts of the earbuds when the earbuds are stowed in the charging case.

According to another aspect of the disclosure, a wearable device assembly is provided. The wearable device assembly comprises: a charging device as described above; a wearable device comprising a battery, wherein the charging device is adapted to charge the battery of the wearable device via a power connection between the charging device and the wearable device.

In one or more embodiments of the present disclosure, the charging device is a charging case for earbuds, the wearable device is a pair of earbuds, and the power source comprises a battery.

In one or more embodiments of the present disclosure, there is no linear charger in the wearable device.

According to another aspect of the disclosure, a charging method for a wearable device assembly as described above is provided. The method comprises: supplying a first voltage, by the buck-boost regulator, to the linear charger, wherein both of the buck-boost regulator and the linear charger are positioned in the charging device; obtaining, by the controller of the charging device, information on the battery of the wearable device from the linear charger and/or the power connection; adjusting the voltage output of the buck-boost regulator, by the controller, based on the obtained information on the battery of the wearable device; supplying the adjusted voltage, by the buck-boost regulator, to the linear charger.

Others systems, method, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the flowing drawings and description. The components in the drawings are not necessarily to scale, emphasis instead being placed upon illustrating the principles of the disclosure. Moreover, in the figures, like reference numerals designate corresponding parts throughout the different views.

FIG. 1 is a block diagram of an earbud assembly according to one or more embodiments of the present disclosure;

FIG. 2 is a block diagram of an earbud assembly according to one or more further embodiments of the present disclosure;

FIG. 3 shows a perspective view of an earbud assembly according to one or more embodiments of the present disclosure;

FIG. 4 is a block diagram of a wearable device assembly according to one or more embodiments of the disclosure;

FIG. 5 is a block diagram of a wearable device assembly according to one or more embodiments of the disclosure;

FIG. 6 shows a charging curve of a battery, such as a Lithium Ion battery;

FIG. 7 shows a charging process according to one or more embodiments of the present disclosure.

### BRIEF DESCRIPTION OF THE PREFERRED EMBODIMENTS

Hereinafter, the preferred embodiments of the present disclosure will be described in more detail with reference to the accompanying drawings.

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various elements, components, steps or calculations, these elements, components, steps or calculations should not be limited by these terms, rather these terms are only used to distinguish one element, component, step or calculation from another. For example, a first component could be termed a second component, similarly a first calculation could be termed a second calculation; similarly a first step could be termed a second step; all without departing from the scope of this disclosure.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

A charging curve of a battery, such as a Lithium Ion battery, has a constant current (CC) phase, followed by a constant voltage (CV) phase. As shown in FIG. 6, in the CC phase, the battery voltage may range from about 3V to about 4.2V while in the CV phase, the battery voltage may be substantially maintained at about 4.2V. In a prior art earbud assembly where a voltage from a battery in the charging case may first be boosted to 5V by a DC-DC converter and then the boosted 5V voltage is supplied to a linear charger of earbuds, the efficiency for boosting the battery voltage to 5V may be about 90% and the efficiency for a 5V voltage to charge the battery may be equal to a ratio of the battery voltage of the earbud to the 5V voltage. For example, the charging efficiency for a 5V voltage to charge the battery may range from about ⅗ to about 4.2/5 in the CC phase and the charging efficiency may be about 4.2/5 in the CV phase. Thus, the total charging efficiency of the prior art charging may range from 54% (=90%*⅗) to 75.6% (=90%*4.2/5), which may be low and undesirable.

The present disclosure provides for an earbud assembly comprising a charging case and a pair of earbuds. The charging case comprises a battery; a DC-DC converter electrically connected to the battery, and adapted to receive input from the battery and provide a voltage output; a controller that is in communication with the DC-DC converter; a linear charger electrically connected to the DC-DC converter and adapted to receive the voltage output from the DC-DC converter and provide a voltage to charge a battery in the earbuds via a power connection between the charging case and the earbuds. Since the linear charger is provided in the charging case, there is no linear charger in the earbuds, and thus the earbuds may be more compact, have a smaller weight, or may have a larger battery without increasing the size of the earbuds. The power connection may be a wired connection established through engagement of contacts of the charging case and the earbuds.

In one or more embodiments of the present disclosure, the DC-DC converter is a buck-boost regulator, which is adapted to provide a variable voltage output. The controller is electrically connected to the linear charger and/or the power connection and adapted to receive input from the linear charger and/or the power connection, and adapted to be communicated with the buck-boost regulator so as to control the buck-boost regulator to adjust its voltage output based on the input from the linear charger and/or the power connection.

The charging loss is equal to the voltage difference between the output voltage of the buck-boost regulator and the voltage of the battery in the earbuds multiplied by the current. Since the output voltage of the buck-boost regulator may be adjusted based on the input from the linear charger and/or the power connection, the output voltage of the buck-boost regulator may be adjusted to be always slightly higher than the voltage of the battery in the earbud. Therefore, the charging efficiency of the present disclosure may be improved significantly. In one or more embodiments of the present disclosure, the output voltage of the buck-boost regulator may be 0.2-0.3V higher than the voltage of the battery of the earbuds.

Since there is no linear charger in the earbuds, the power connection (contacts) between the charging case and the earbuds may be directly electrically connected to the battery of the earbud, and thus the controller of the charging case may communicate with the linear charger directly and/or may measure or obtain the voltage of the battery of the earbuds directly. The controller of the charging case may obtain the battery status of the earbuds more quickly, and thus the output voltage of the buck-boost regulator may match the battery status more accurately, resulting in an improved charging efficiency.

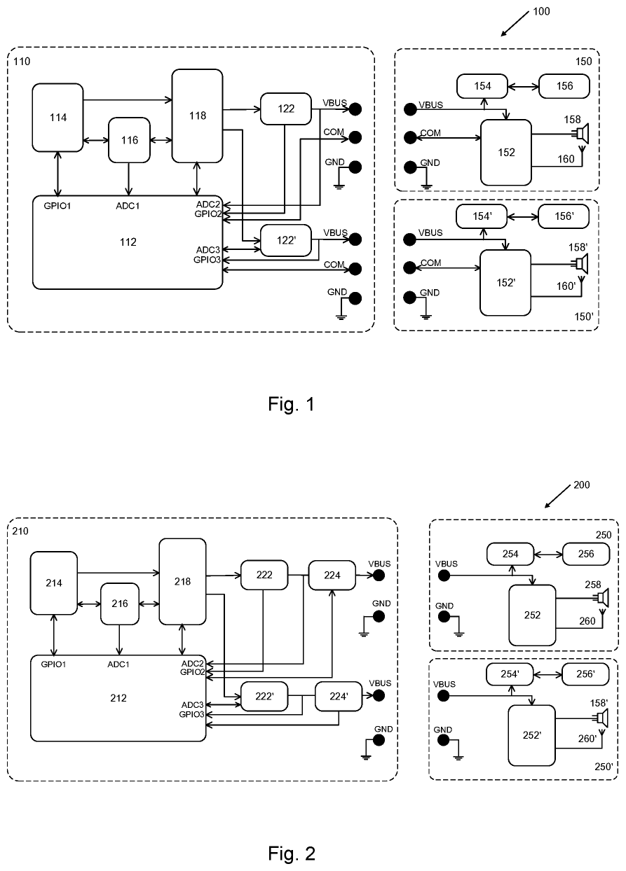

FIG. 1 is a block diagram of an earbud assembly 100 according to one or more embodiments of the present disclosure. The earbud assembly 100 comprises a charging case 110 and a pair of earbuds 150, 150′. The pair of the earbuds 150, 150′ may be stowed in the charging case 110 when not in use. As shown, the charging case 110 comprises a controller 112, a charger element 114, a battery 116, a buck-boost regulator 118 and a pair of linear chargers 122, 122′, and two sets of contacts each comprising three contacts VBUS, COM, GND. The earbud 150 comprises a controller 152, a protection IC 154, a battery 156, a speaker 158 and an antenna 160, and three contacts, i.e., VBUS, COM, GND. The earbud 150′ comprises a controller 152′, a protection IC 154′, a battery 156′, a speaker 158′ and an antenna 160′, and three contacts, i.e., VBUS, COM, GND. When the earbud 150 is stowed in the charging case 110, each of the contacts VBUS, COM, GND of the earbuds 150 is in contact with and thus electrically connected to a corresponding contact in the first set of contacts VBUS, COM, GND of the charging case 110 and thus a power line or connection and a communication line between the charging case 110 and the earbud 150 are established. The charging case 110 charges the earbud 150 via the power line or connection and communicates with the earbud 150 via the communication line. When the earbud 150′ is stowed in the charging case 110, each of the contacts VBUS, COM, GND of the earbuds 150′ is in contact with and thus electrically connected to a corresponding contact in the second set of contacts VBUS, COM, GND of the charging case 110 and thus a power line or connection and a communication line between the charging case 110 and the earbud 150′ are established. The charging case 110 charges the earbud 150′ via the power line or connection and communicates with the earbud 150′ via the communication line.

The charger element 114 is electrically connected to the battery 116 and is configured to charge the battery 116 by using power supply from an external power source when the charging case 110 is connected to the external power source. The buck-boost regulator 118 is electrically connected to the battery 116, and is adapted to receive power supply from the battery 116 and provide a variable voltage output. Each of the linear chargers 122, 122′ is electrically connected to the buck-boost regulator 118 and is adapted to receive the voltage output from the buck-boost regulator 118. The linear charger 122 is configured to provide a voltage to charge the battery 156 in the earbud 150 via a power line or connection between the charging case 110 and the earbud 150. The power line or connection is established when the earbud 150 is stowed in the charging case 110. The linear charger 122′ is configured to provide voltage to charge the battery 156′ in the earbud 150′ via a power line or connection between the charging case 110 and the earbud 150′. The power line or connection is established when the earbud 150′ is stowed in the charging case 110. Each of the linear chargers 122, 122′ is configured to receive a voltage higher than that of the battery 152, 152′ to be charged, and regulates the voltage drop between the received voltage and the battery 152, 152′ to keep a load voltage/current to the battery 152, 152′ stable, e.g., by inserting a resistive device.

As shown, the controller 112 is adapted to be in communication with the charger element 114, the battery 116, the buck-boost regulator 118 and the linear charger 122. The controller 112 is also electrically connected to the contactor VBUS of the charging case 110. During operation, the controller 112 is adapted to obtain a status of the battery 116 and receive input from the linear changer 122. The controller is also adapted to obtain an electrical property, such as a voltage, of the contact VBUS of the first set of contacts. The input received from the linear changer 122 by the controller may be information that may reflect, or be associated to, the status of the battery 156. The information may be, e.g., charging voltage, charging current and/or temperature. The controller is also adapted to communicate with the buck-boost regulator 118, so as to adjust the output voltage of the buck-boost regulator based on input from the battery 116, the linear charger 122 and/or the voltage of the contact VBUS.

The buck-boost regulator 118 may have three operating modes, i.e., a buck mode, a boost mode and a bypass mode. When the charging case 110 is connected to an external power source and the charging case 110 is charging the earbuds 150, 150′ stowed therein, the buck-boost regulator 118 receives power supply from the charger element 114 and works in the bypass mode, in which the buck-boost regulator 118 simply provides the voltage supply from the charger element 114 to the linear charger 122 without changing the voltage. When the charging case 110 is not connected to an external power source and the charging case 110 is charging the earbuds 150, 150′ stowed therein, the buck-boost regulator 118 receives voltage supply from the battery 116 and will work in one of the three operating modes, i.e., a buck mode, a boost mode and a bypass mode, depending on the status of the battery 116 and the status of the battery 156, 156′.

In one or more embodiments of the present disclosure, a desirable output voltage range of the buck-boost regulator 118 may be about 0.2-0.3V higher than the voltage of the battery 156, 156′, so as to optimize the charging efficiency. In one or more embodiments of the present disclosure, when the voltage of the battery 116 is higher than the voltage of battery 156 by 0.3-0.5V, the buck-boost regulator 118 works in the bypass mode, in which the voltage supply from the battery 116 is provided to the linear charger 122 without substantial voltage changing; when the voltage of the battery 116 is higher than the voltage of battery 156 by more than 0.5V, the buck-boost regulator 118 works in the buck mode, in which the output voltage of the buck-boost regulator 118 is lower than that of the battery 116 so that it is within the desirable output voltage range; when the voltage of the battery 116 is no higher than the voltage of battery 156 or higher than the voltage of battery 156 by less than 0.2-0.3V, the buck-boost regulator 118 works in the boost mode, in which the output voltage of the buck-boost regulator 118 is boosted so that it is within the desirable output voltage range.

A charging efficiency of one or more exemplary embodiments of the present disclosure may be as follows. As shown in FIG. 6, in the CC phase, the battery voltage may range from about 3V to about 4.2V while in the CV phase, the battery voltage may be substantially maintained at about 4.2V. That is, the voltage of the battery 156 may range from 3V to 4.2V. In a bypass mode, the voltage of the battery 116 may be 0.3-0.5V higher than the voltage of the battery 156. The charging efficiency may ranges from about 85.7% (=3/3.5, when the voltage of the battery 156 is 3V while the voltage of the battery 116 is 3.5V) to 92.8% (=3.9/4.2, when the voltage of the battery 156 is 3.9 V while the voltage of the battery 116 is 4.2V). In the buck mode, the charging efficiency may ranges from about 81.8% (=0.9*3/3.3, when the voltage of the battery 156 is 3V while the output voltage of the buck-boost regulator is 3.3V) to 83.99% (=0.9*4.2/4.5, when the voltage of the battery 156 is 4.2V while the output voltage of the buck-boost regulator is 4.5V). In the boost mode, the charging efficiency may range from 81.8% (=0.9*3/3.3, when the voltage of the battery 156 is 3V while the output voltage of the buck-boost regulator is 3.3V) to 83.99% (0.9*4.2/4.5, when the voltage of the battery 156 is 4.2V while the output voltage of the buck-boost regulator is 4.5V). Therefore, the present disclosure may have an improved charging efficiency as compared to the prior art charging case.

As shown in FIG. 1, the linear charger 122 for the battery 156 of the earbuds 150 is positioned in the charging case 110, and there is no linear charger in the earbuds 150. Thus, when the earbuds 150 is stowed in the charging case 110, the contact VBUS of the charging case 110 may be electrically connected to the battery 156 through the contact VBUS of the earbud 150 and the protection IC 154. Since there is no linear charger positioned between the contact VBUS of the charging case 110 and the battery 156, there is almost no voltage drop between the contact VBUS of the charging case 110 and the battery 156. When the earbud 150 is being charged in the charging case 110, it may be considered that the voltage of the contact VBUS is substantially equal to the voltage of the battery 156. Therefore, the controller 112 may measure or obtain the voltage of the battery 156 directly.

As described above, the controller 112 may be in communication with the linear charger 122 for the battery 156 directly, and can obtain or measure the voltage of the battery 156 directly. Thus, the controller 112 may obtain the battery status of the earbuds very quickly in a timely manner.

In the one or more embodiments shown in FIG. 1, the controller 112 may obtain the status of the battery 116, input from the linear charger 122 and electrical property, such as voltage, of the battery 156, and control the operation of the buck-boost regulator 118 to adjust the output voltage of buck-boost regulator 118, so as to match the battery status of the battery 156, such as the voltage of the battery 156. As compared to a prior art earbud assembly in which the linear charger for the battery of the earbud is positioned in the earbud, the embodiment of the present disclosure may obtain the status of the battery of the earbuds more quickly, and thus the output voltage of the buck-boost regulator may be adjusted to match the battery status more accurately in a timely manner, resulting in an improved charging efficiency.

In the one or more embodiments shown in FIG. 1, the linear charger 112′, the second set of contacts VBUS, COM, GND of the charging case 110, the earbud 150′ may be similar to the linear charger 112, the first set of contacts VBUS, COM, GND of the charging case 110, the earbud 150, and thus detailed description therefor is omitted.

In the embodiments shown, the controller 122 is adapted to be in communication with the linear charger 122 and is electrically connected to the contactor VBUS of the charging case 110 so that it may read or obtain the status of the battery 156 and receive input from the linear changer 122. However, the present disclosure is not limited thereto. In one or more embodiments of the present disclosure, the controller may be adapted to be in communication with the linear charger 122 but may not be electrically connected to the contactor VBUS of the charging case 110. Or alternatively, the controller may be electrically connected to the contactor VBUS of the charging case 110, but may not be adapted to be in communication with the linear charger 122.

In the embodiments shown in FIG. 1, the buck-boost regulator 118 has three operating modes, i.e., a bypass mode, a buck mode and a boost mode, so as to adjust the output voltage of the buck-boost regulator 118 to provide a variable voltage output to match the battery status of the earbud battery. However, the present disclosure is not limited thereto. In one or more embodiments of the present disclosure, the buck-boost regulator 118 may be a DC-DC converter that may provide a stable voltage output, such as a stable 5V voltage output.

FIG. 2 is a block diagram of an earbud assembly 200 according to one or more further embodiments of the present disclosure. The earbud assembly 200 comprises a charging case 210 and a pair of earbuds 250, 250′. The pair of the earbuds 250, 250′ may be stowed in the charging case 210 when not in use. As shown, the charging case 210 comprises a controller 212, a charger element 214, a battery 216, a buck-boost regulator 218, a pair of linear chargers 222, 222′, a pair of switch devices 224, 224′, and two sets of contacts each comprising two contacts VBUS, GND. The earbud 250 comprises a controller 252, a protection IC 254, a battery 256, a speaker 258 and an antenna 260, and two contacts, i.e., VBUS, GND. The earbud 250′ comprises a controller 252′, a protection IC 254′, a battery 256′, a speaker 258′ and an antenna 260′, and two contacts, i.e., VBUS, GND. The embodiments shown in FIG. 2 is similar to those shown in FIG. 1, except that in FIG. 2, the contacts COM and the communication line is omitted, and the communication between the charging case 210 and the earbuds 250, 250′ is performed through the power line and the contacts VBUS. Particularly, in FIG. 1, each set of the contacts of the charging case and each of the earbuds comprise three contacts, i.e., VBUS, COM, GND, while in FIG. 2, each set of the contacts of the charging case and each of the earbuds comprise only two contacts, i.e., VBUS, GND. As shown in FIG. 2, a switch device 224 is provided between the linear charger 222 and the contact VBUS in the first set of contacts of the charging case 210, and a switch device 224′ is provided between the linear charger 222′ and the contact VBUS in the second set of contacts. The controller 212 is adapted to be in communication with the switch devices 224, 224′, so that it may operate in one of two operating modes. In the first operating mode of the switch device, the linear charger 222 may be electrically connected to a corresponding contact VBUS so that the voltage supply from the linear charger may be provided to the battery of the earbud via the contacts VBUS to charge the earbud, while in the second operating mode, the controller is electrically connected to a corresponding contact VBUS, so as to communicate with the earbuds via the contact VBUS.

As described above, in the present disclosure, the linear chargers for the battery of the earbuds are positioned in the charging case and thus the controller may obtain the battery status of the earbuds very quickly in a timely manner without communicating with the earbuds. Thus, the charging case of the present disclosure may be able to provide a variable charging voltage to match the status of the earbud battery so as to improve the charging efficiency without communicating with the earbuds during the charging. Thus, it may be possible and advantageous to omit the contact COM and the communication line.

Other elements and operations of the embodiments shown in FIG. 2 are similar or the same to those of the embodiments shown in FIG. 1, and thus detailed description therefor is omitted.

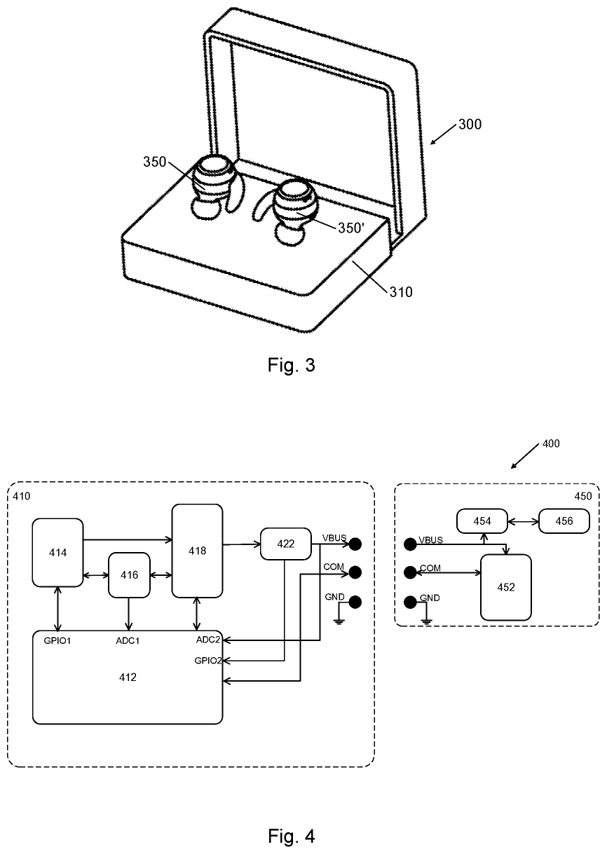

FIG. 3 shows a perspective view of an earbud assembly 300 according to one or more embodiments of the present disclosure. The earbud assembly 300 comprises a charging case 310 and a pair of earbuds 350, 350′. The earbuds 350, 350′ may be stowed in the charging case 310 when not in use. The charging case and earbuds shown in FIG. 3 are merely illustrative, and the present disclosure is not limited thereto. In one or more other embodiments according to the present disclosure, the charging box and earbuds may have any suitable appearance or shape.

The present disclosure has been described in connection with charging cases for earbuds and earbud assemblies shown in FIGS. 1-3. However, the present disclosure is not limited to charging cases for earbuds and earbud assemblies. According to one or more embodiments, the present disclosure may apply to a wearable device assembly. The wearable device of the present disclosure may be, e.g., a smart watch, a smart bracelet.

FIG. 4 is a block diagram of a wearable device assembly 400 according to one or more embodiments of the disclosure. The wearable device assembly 400 comprises a wearable device 450 and a charging device 410 for charging the wearable device 450. As shown, the charging device 410 comprises a controller 412, a charger element 414, a battery 416, a buck-boost regulator or a DC-DC converter 418, a linear charger 422, and a set of contacts each comprising three contacts VBUS, COM, GND. The wearable device 450 comprises a controller 452, a protection IC 454, a battery 456, and three contacts, i.e., VBUS, COM, GND. When the charging device 410 is charging the wearable device 450, each of the contacts VBUS, COM, GND of the earbuds 450 is in contact with and thus electrically connected to a corresponding contact in the contacts VBUS, COM, GND of the charging device 410 and thus a power line or connection and a communication line between the charging case 410 and the wearable device 450 are established. The charging device 410 charges the wearable device 450 via the power line or connection and communicates with the wearable device 450 via the communication line.

Other elements and operations of the embodiments shown in FIG. 4 are similar or the same to those of the embodiments shown in FIG. 1, and thus detailed description therefor is omitted.

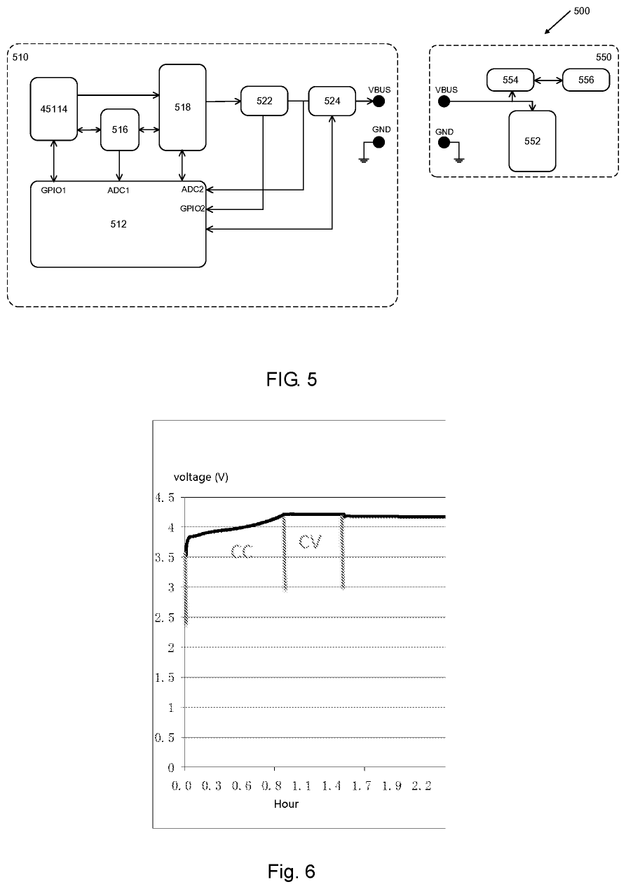

FIG. 5 is a block diagram of a wearable device assembly 500 according to one or more embodiments of the disclosure. The wearable device assembly 500 comprises a wearable device 550 and a charging device 510 for charging the wearable device 550. As shown, the charging device 510 comprises a controller 512, a charger element 514, a battery 516, a buck-boost regulator or a DC-DC converter 518, a linear charger 522, a switch device 524 and two contacts VBUS, GND. The wearable device 550 comprises a controller 552, a protection IC 554, a battery 556, and two contacts, i.e., VBUS, GND. When the charging device 510 is charging the wearable device 550, each of the contacts VBUS, GND of the earbuds 550 is in contact with and thus electrically connected to a corresponding contact of the charging device 510 and thus a power line or connection between the charging device 510 and the wearable device 550 is established. The charging device 510 charges the wearable device 550 via the power line or connection.

Other elements and operations of the embodiments shown in FIG. 5 are similar or the same to those of the embodiments shown in FIG. 2, and thus detailed description therefor is omitted.

In the embodiments shown in FIGS. 4, 5, the wearable assembly comprises a charging device and a wearable device. However, the present disclosure is not limited thereto. In one or more other embodiments of the present disclosure, the wearable assembly may comprises more than one wearable device, such as two wearable devices or three wearable devices.

In the embodiments shown, the charger element 114, 214, 414, 514 and the buck-boost regulator 118, 218, 418, 518 are separate elements. However, the present disclosure is not limited thereto, and in one or more other embodiments of the present disclosure, the charger element and the buck-boost regulator may be integrated in one component.

In the embodiments shown, the protection IC 154, 254, 454, 554 and the battery 156, 256, 456, 556 are separate elements. The present disclosure is not limited thereto, and in one or more other embodiments of the present disclosure, the protection IC 154, 254, 454, 554 and the battery 156, 256, 456, 556 may be integrated in one component. Similarly, the protection IC 154′, 254′ and the battery 156′, 256′ may be integrated in one component as well.

In one or more embodiments of the present disclosure, the buck-boost regulator may be a High-Efficiency Buck-Boost Converter of Model MAX77813 that is commercially available from Maxim Integrated Products, Inc. However, the present disclosure is not limited thereto. Any suitable buck-boost regulator or converter or DC-DC converter may be used in the present disclosure. In one or more embodiments of the present disclosure, the linear charger may be a linear charger of Model bq2404x that is commercially available from Texas Instruments. However, the present disclosure is not limited thereto. Any suitable linear charger may be used in the present disclosure.

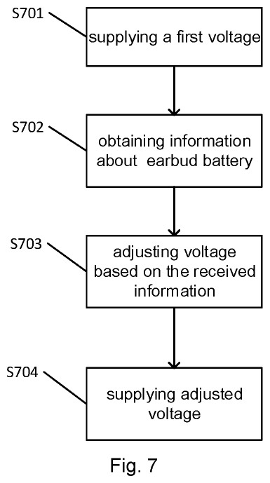

FIG. 7 shows the charging process according to one or more embodiments of the present disclosure. In step S701, the buck-boost regulator supplies a first voltage to the linear charger(s). For example, the first voltage may be, for example, a default voltage supplied upon detection of a power connection between the charging device or charging case and the wearable device or earbuds. For example, when the charging case detects a presence of the earbuds stowed therein, the buck-boost regulator may supply the first voltage to the linear charger(s). In step S702, the controller obtains information on the battery of the wearable device. As shown in FIGS. 1-2, 4-5 and as described above, the linear charger for the battery of the wearable device is positioned in the charging device, and there is no linear charger in the wearable device, and there is almost no voltage drop between the contact VBUS of the charging device and the battery of the wearable device. Therefore, the controller may obtain information on the battery of the wearable device directly. In step S703, the controller communicates with the buck-boost regulator and adjusts the voltage output of the buck-boost regulator based on the obtained information on the battery of the wearable device. In one or more embodiments of the present disclosure, the controller may adjusts the voltage output of the buck-boost regulator based on the obtained information about the battery of the wearable device and the information on the battery of the charging device. In step S704, the buck-boost regulator supplies the adjusted voltage to the linear charger(s).

According to one or more embodiments of the disclosure, the present disclosure can be implemented as follows.

Item 1: A charging device for a wearable device, the charging device comprising:
a power source;
a DC-DC converter electrically connected to the power source, and adapted to receive input from the power source and provide a voltage output;
a controller that is in communication with the DC-DC converter;
a linear charger electrically connected to the DC-DC converter and adapted to receive the voltage output from the DC-DC converter and provide a voltage output to charge a battery in the wearable device via a power connection between the charging device and the wearable device.

Item 2: The charging device according to Item 1, wherein the DC-DC converter is a buck-boost regulator adapted to provide a variable voltage output.

Item 3: The charging device according to any of Items 1-2, wherein the controller is electrically connected to the linear charger and/or the power connection and adapted to receive input from the linear charger and/or the power connection, and adapted to communicated with the buck-boost regulator so as to control the buck-boost regulator to adjust its voltage output based on the input from the linear charger and/or the power connection.

Item 4: The charging device according to any of Items 1-3, wherein the charging device is a charging case for earbuds, the wearable device is a pair of earbuds, and the power source comprises a battery.

Item 5: The charging device according to any of Items 1-4, wherein the linear charger comprises a first and second linear chargers.

Item 6: The charging device according to any of Items 1-5, wherein
the first linear charger is electrically connected to the buck-boost regulator and adapted to receive a first voltage output from the buck-boost regulator and provide a voltage output to charge a first earbud of the pair of the earbuds,
the second linear charger is electrically connected to the buck-boost regulator and adapted to receive a second voltage output from the buck-boost regulator and provide a voltage output to charge a second earbud of the pair of the earbuds.

Item 7: The charging device according to any of Items 1-6, wherein the first voltage output is independent from the second voltage output.

Item 8: The charging device according to any of Items 1-7, wherein the first voltage output is 0.2-0.3 V higher than the voltage of the battery in the first earbud, and the second voltage output is 0.2-0.3 V higher than the voltage of the battery in the second earbud.

Item 9: The charging device according to any of Items 1-8, wherein the power connection is established through an engagement between contacts of the charging case and contacts of the earbuds when the earbuds are stowed in the charging case.

Item 10: A wearable device assembly, comprising:
a charging device according any of Items 1-9;
a wearable device comprising a battery,
wherein the charging device is adapted to charge the battery of the wearable device via a power connection between the charging device and the wearable device.

Item 11: The wearable device assembly according to Item 10, wherein the charging device is a charging case for earbuds, the wearable device is a pair of earbuds, and the power source comprises a battery.

Item 12: The wearable device assembly according to any of Items 10-11, wherein there is no linear charger in the wearable device.

Item 13: A charging method for a wearable device assembly according to any of Items 10-12, comprising:
supplying a first voltage, by the buck-boost regulator, to the linear charger, wherein both of the buck-boost regulator and the linear charger are positioned in the charging device;
obtaining, by the controller of the charging device, information on the battery of the wearable device from the linear charger and/or the power connection;
adjusting the voltage output of the buck-boost regulator, by the controller, based on the obtained information on the battery of the wearable device;
supplying the adjusted voltage, by the buck-boost regulator, to the linear charger.

Systems and methods have been described in general terms as an aid to understanding details of the disclosure. In some instances, well-known structures, materials, and/or operations have not been specifically shown or described in detail to avoid obscuring aspects of the disclosure. In other instances, specific details have been given in order to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the disclosure. Accordingly, the disclosure is not to be restricted except in light of the attached claims and their equivalents.

1. A charging device for a wearable device, the charging device comprising:
a power source;
a DC-DC converter electrically connected to the power source, and adapted to receive input from the power source and provide a voltage output;
a controller that is in communication with the DC-DC converter;
a linear charger electrically connected to the DC-DC converter and adapted to receive the voltage output from the DC-DC converter and provide a voltage output to charge a battery in the wearable device via a power connection between the charging device and the wearable device.

2. The charging device according to claim 1, wherein the DC-DC converter is a buck-boost regulator adapted to provide a variable voltage output.

3. The charging device according to claim 2, wherein the controller is electrically connected to the linear charger and/or the power connection and adapted to receive input from the linear charger and/or the power connection, and adapted to communicated with the buck-boost regulator so as to control the buck-boost regulator to adjust its voltage output based on the input from the linear charger and/or the power connection.

4. The charging device according to claim 1, wherein the charging device is a charging case for earbuds, the wearable device is a pair of earbuds, and the power source comprises a battery.

5. The charging device according to claim 4, wherein the linear charger comprises a first and second linear chargers.

6. The charging device according to claim 5, wherein
the first linear charger is electrically connected to the buck-boost regulator and adapted to receive a first voltage output from the buck-boost regulator and provide a voltage output to charge a first earbud of the pair of the earbuds,
the second linear charger is electrically connected to the buck-boost regulator and adapted to receive a second voltage output from the buck-boost regulator and provide a voltage output to charge a second earbud of the pair of the earbuds.

7. The charging device according to claim 6, wherein the first voltage output is independent from the second voltage output.

8. The charging device according to claim 6, wherein the first voltage output is 0.2-0.3 V higher than the voltage of the battery in the first earbud, and the second voltage output is 0.2-0.3 V higher than the voltage of the battery in the second earbud.

9. The charging device according to claim 4, wherein the power connection is established through an engagement between contacts of the charging case and contacts of the earbuds when the earbuds are stowed in the charging case.

10. A wearable device assembly, comprising:
a charging device according claim 1;
a wearable device comprising a battery,
wherein the charging device is adapted to charge the battery of the wearable device via a power connection between the charging device and the wearable device.

11. The wearable device assembly according to claim 10, wherein
the charging device is a charging case for earbuds, the wearable device is a pair of earbuds, and the power source comprises a battery.

12. The wearable device assembly according to claim 10, wherein there is no linear charger in the wearable device.

13. A charging method for a wearable device assembly according to claim 10, comprising:
supplying a first voltage, by the buck-boost regulator, to the linear charger, wherein both of the buck-boost regulator and the linear charger are positioned in the charging device;
obtaining, by the controller of the charging device, information on the battery of the wearable device from the linear charger and/or the power connection;
adjusting the voltage output of the buck-boost regulator, by the controller, based on the obtained information on the battery of the wearable device;
supplying the adjusted voltage, by the buck-boost regulator, to the linear charger.
